(19) United States
(12) Patent Application Publication
(10) Pub. No.: US 2011/0082774 A1
(43) Pub. Date: Apr. 7, 2011

(54) Inventory Optimizer

(76) Inventor: Mark L. Spearman, Bryan, TX (US)

(21) Appl. No.: 12/898,498

(22) Filed: Oct. 5, 2010

Related U.S. Application Data
(60) Provisional application No. 61/249,325, filed on Oct. 7, 2009.

(51) Int. Cl. G06Q 10/00

(52) U.S. Cl. 705/28

(57) ABSTRACT

Embodiments of the present disclosure include a computer implemented method for an automated selection of an optimal inventory strategy from a set of available strategies based, at least in part, on a set of optimal individual policies associated with one or more items of a plurality of items maintained in a particular inventory stock.

### CLAIM OF PRIORITY

This application claims the benefit of priority from U.S. Provisional Patent Application Ser. No. 61/249,325 filed on Oct. 7, 2009 and entitled “An Inventory Optimizer,” which is fully incorporated herein by reference for all purposes.

### FIELD

Certain embodiments of the present disclosure generally relate to a method and apparatus for inventory management and, more particularly, an automated system for selecting an optimal inventory strategy within certain business constraints.

### BACKGROUND

Inventory management is an essential component of management of a manufacturing facility or network of facilities. Manufacturing Requirements Planning (MRP) and Enterprise Resource Planning (ERP) systems have been used for decades to provide material plans for manufacturing but with limited success. Users of these systems generally find that they must “massage” the output from these systems in order to avoid excessive stock and/or poor customer service.

### SUMMARY

Certain embodiments provide a method for selecting an optimal inventory strategy for a plurality of stock keeping units (SKUs). A stock keeping unit is a unique identifier for a part, item, sub-assembly, assembly, substance, fluid, etc. The method generally includes selecting an optimal policy for each SKU of the plurality of SKUs based, at least in part, on a potential backorder delay of each SKU, calculating a set of efficient frontier curves based on the optimal policy for each SKU of the plurality of SKUs, displaying the set of efficient frontier curves illustrating the relationship between a set of service levels and a total inventory investment, and selecting the optimal inventory strategy for the plurality of SKUs based, at least in part, on the set of efficient frontier curves.

Certain embodiments provide an apparatus for selecting an optimal inventory strategy for a plurality of stock keeping units (SKUs). The apparatus generally includes means for selecting an optimal policy for each SKU of the plurality of SKUs based, at least in part, on a potential backorder delay of each SKU, means for calculating a set of efficient frontier curves based on the optimal policy for each SKU of the plurality of SKUs, means for displaying the set of efficient frontier curves illustrating the relationship between a set of service levels and a total inventory investment, and means for selecting the optimal inventory strategy for the plurality of SKUs based, at least in part, on the set of efficient frontier curves.

Certain embodiments provide a computer-program product for selecting an optimal inventory strategy for a plurality of stock keeping units (SKUs) in a suitable computer, the computer-program product comprising a computer readable medium having instructions thereon. The instructions generally include code for selecting an optimal policy for each SKU of the plurality of SKUs based, at least in part, on a potential backorder delay of each SKU, code for calculating a set of efficient frontier curves based on the optimal policy for each SKU of the plurality of SKUs, code for displaying the set of efficient frontier curves illustrating the relationship between a set of service levels and a total inventory investment, and code for selecting the optimal inventory strategy for the plurality of SKUs based, at least in part, on the set of efficient frontier curves.

### BRIEF DESCRIPTION OF THE DRAWINGS

So that the manner in which the above-recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 is a block diagram of a computer system illustrating an exemplary embodiment of the present disclosure.

FIG. 2 is a block diagram of a computer system illustrating another embodiment of the present disclosure.

FIG. 3 illustrates a typical graph of frontier curves used to set an optimal inventory strategy.

FIG. 4 illustrates a typical partial output of one embodiment of the disclosure showing the input data and the optimal policy parameters for five SKUs.

FIG. 5 defines certain symbols which may be utilized in certain embodiments of the disclosure.

FIG. 6 illustrates certain formulas which may be utilized in embodiments of the present disclosure.

FIG. 7 illustrates an exemplary algorithm for setting an optimal policy for one item, in accordance with embodiments of the disclosure.

FIG. 8 illustrates an exemplary algorithm for setting an inventory strategy for plurality of items, in accordance with embodiments of the disclosure.

FIG. 9 illustrates an exemplary algorithm for preparing an efficient frontier curve, in accordance with embodiments of the disclosure.

### DETAILED DESCRIPTION

An automated inventory control module (ICM) can help track large shipments, track inventory investment, and alert the manufacturer when it is time to reorder. Some previous ICMs have attempted to address the problem of minimizing inventory investment while maintaining a specified service level. However, embodiments of the present disclosure differ from previous attempts in that embodiments of this disclosure address the problem of minimizing inventory investment, while balancing service level constraints with a minimization of backorder delays. Nonetheless, because of its common usage, fill rate will be reported.

The incorporation of this additional service consideration (i.e., minimizing backorder delays) in an ICM is extremely important because, although commonly used, service level alone is a very misleading measure of performance. For example, which scenario is preferable, meeting a service demand with on hand stock 95% of the time but having a back order delay of a week when a service demand cannot be met or meeting a service demand with on hand stock 85% of the time but having a back order delay of mere hours? Clearly both service considerations must be taken into account. To facilitate decision making, both fill rate and average backorder time given a backorder are reported. Embodiments of the present disclosure also include the ability to report the probability of satisfying a demand within a given length of time.

Among other things, the present disclosure solves the problem of minimizing inventory investment while balancing a minimum given service level and the number of “replenishment events,” with a focus towards reducing backorder delays. Embodiments of the present disclosure include a computer implemented method for an automated selection of an optimal inventory strategy from a set of available strategies based, at least in part, on a set of optimal individual policies associated with one or more items of a plurality of items maintained in a particular inventory stock. Embodiments may utilize input data for the one or more inventory items to be considered. For example, certain embodiments may use the mean and variance of a number of demand instances, the mean and variance of the size of the demand instances, the mean and variance of one or more replenishment times, and a standard cost for the one or more items of the plurality of items. The method may calculate an optimal policy for each of the one or more inventory items and calculate a strategy for the plurality of items which may be used to prepare an efficient frontier curve which the best possible performance for a given set of conditions. This curve will typically show the amount of inventory ($) required to achieve a given fill rate (% on time) and a given reorder frequency (or, given reorder cost). Any point on an efficient frontier curve will represent the lowest inventory investment for the given fill rate and reorder frequency (cost).

### An Example Inventory Control System

In the following, reference is made to embodiments of the present disclosure. However, it should be understood that the present disclosure is not limited to specific described embodiments. Instead, any combination of the following features and elements, whether related to different embodiments or not, is contemplated to implement and practice the present disclosure. Furthermore, in various embodiments the disclosure provides numerous advantages over the prior art. However, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the present disclosure” shall not be construed as a generalization of any inventive subject matter disclosed herein and shall not be considered to be an element or limitation of the appended claims except where explicitly recited in a claim(s).

One embodiment of the present disclosure is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive and DVDs readable by a DVD player) on which information is permanently stored; and (ii) writable storage media (e.g., floppy disks within a diskette drive, a hard-disk drive or random-access memory) on which alterable information is stored. Such computer-readable storage media, when carrying computer-readable instructions that direct the functions of the present disclosure, are embodiments of the present disclosure. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present disclosure, are embodiments of the present disclosure. Broadly, computer-readable storage media and communications media may be referred to herein as computer-readable media.

In general, the routines executed to implement the embodiments of the disclosure, may be part of an operating system or a specific application, component, program, module, object, or sequence of instructions. The computer program of the present disclosure is typically comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the disclosure. However, it should be appreciated that any particular program nomenclature that follows is used merely for convenience, and thus embodiments should not be limited to use solely in any specific application identified and/or implied by such nomenclature.

A client system may generally include a central processing unit (CPU) connected by a bus to memory and storage. Each client system is typically running an operating system configured to manage interaction between the computer hardware and the higher-level software applications running on the client system. The server system may include hardware components similar to those used by the client system (e.g., a CPU, a memory, and a storage device, coupled by a bus). However, such a network environment is merely an example of one computing environment. Embodiments of the present disclosure may be implemented using other environments, regardless of whether the computer systems are complex multi-user computing systems, such as a cluster of individual computers connected by a high-speed network, single-user workstations, or network appliances lacking non-volatile storage. Further, embodiments of the disclosure may be implemented using computer software applications executing on existing computer systems, e.g., desktop computers, server computers, laptop computers, tablet computers, and the like. However, the software applications described herein are not limited to any currently existing computing environment or programming language, and may be adapted to take advantage of new computing systems as they become available.

While embodiments of the disclosure may be susceptible to various modifications and alternative forms, specific embodiments thereof are shown by way of example in the drawings and will herein be described in detail. The drawings may not be to scale. It should be understood, however, that the drawings and detailed description thereto are not intended to limit embodiments to the particular form disclosed, but to the contrary, the intention is to cover all modifications, equivalents, and alternatives falling within the spirit and scope of the present disclosure as defined by the appended claims.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments of the disclosure.

It is to be understood that the forms of the disclosure shown and described herein are to be taken as examples of embodiments. Elements and materials may be substituted for those illustrated and described herein, parts and processes may be reversed, and certain features of the disclosure may be utilized independently, all as would be apparent to one skilled in the art after having the benefit of this disclosure. Changes may be made in the elements described herein without departing from the spirit and scope of the disclosure as described in the following claims.

Embodiments of the disclosure provide systems and methods to determine the minimum amount of inventory investment (i.e., the expected amount of money tied up in inventory) for a plurality of stock keeping units (SKUs) that will satisfy a minimum acceptable service level (specified as the percent of the time that a service demand is satisfied from stock) and is within a given capacity availability (specified as the maximum number of inventory replenishments in a given time). A SKU is a unique identifier for a part, item, sub-assembly, substance, fluid, etc., which is part of the inventory. The purpose and utility of these embodiments is to allow the user to choose an optimal inventory strategy from a set of available strategies and then to convert the strategy into optimal individual policies for each item maintained in a particular stock. The word optimal is used here to mean that the inventory investment required to achieve a given service level within a set capacity will be minimized.

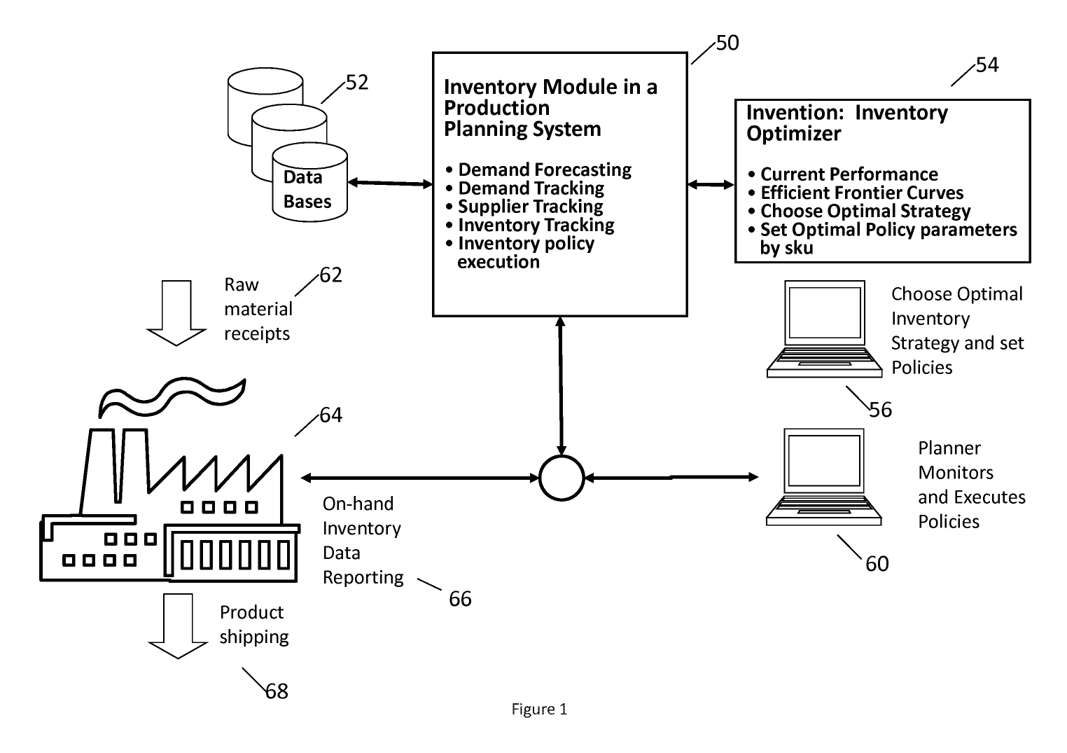

The functionality provided by the disclosure may operate with or be embodied in other systems as well. FIG. 1 is just one exemplary version. The Inventory Optimizer (IO) 54 supplies the functionality according to principles of the disclosure and may be implemented as one or more respective software modules operating on a suitable computer. The suitable computer typically comprises a processing unit, a system memory which might include both temporary random access memory and more permanent storage such as a disk drive, and a system bus that couples the processing unit to the various component so the computer. This computer is shown functioning as a server 56, but this is not a requirement.

An exemplary embodiment of the disclosure may operate with an existing ICM 50, within a Production Planning System (PPS). One purpose of the ICM is to decide when to order new inventory and how much to order. Inventory data is maintained in a data base 52 that may be part of the PPS. The PPS tracks inventory transactions such as raw material receipts 62 received by a facility 64 and products 68 shipping from said facility 64. In addition to such transactions, PPSs typically also have on-hand inventory reporting 66.

The PPS, of which the ICM 50 is a part, provides demand forecasting and tracking, supplier tracking (in particular, supplier lead times), inventory tracking (on hand, on order, and any backorders) and is responsible for executing a given inventory policy. An IO 54 takes data from the ICM and provides a user with an evaluation of current performance, efficient frontier curves, and provides the means to choose an optimal strategy and then set optimal policy parameters for each stock keeping unit (SKU). Such an exercise is done infrequently (e.g., once per month). Planners then make sure the policy is being properly executed and monitor the performance of the policy on a suitable computer 60. In certain implementations the suitable computer 60 may be the same device as server 56. In other embodiments suitable computer 56 may be separate and distinct from server 56.

Current ICM performance, in accordance with embodiments of the present disclosure, involves three considerations: inventory, service level, and capacity. Inventory considerations include but are not limited to, the expected amount of inventory on hand (both in terms of value and units) in total and by individual SKU. Service level considerations include, but are not limited to, percent of time SKUs are in stock, average time SKUs are in stock, average backorder delay, and others. Embodiments may also report on the capacity required to administer the inventory policy including but not limited to the number of replenishments in a given period, the number of changeovers in the plant producing the items and so forth.

For the purposes of this disclosure, the total expected inventory investment is the anticipated average inventory times the unit cost per SKU and then summed over all SKUs in the stock being considered. The aggregate fill rate is the sum of the percent of the time the SKU can fill demand from stock times the average demand divided by the sum of the average demand. The number of replenishments is the total demand during the specified period divided by the reorder quantity.

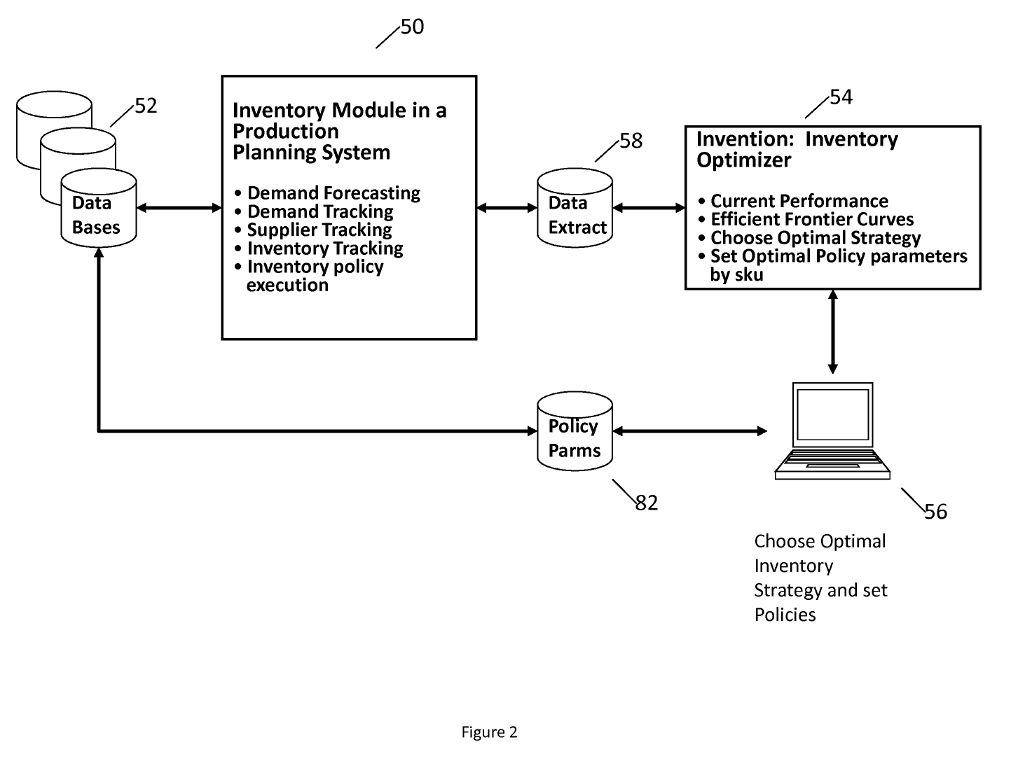

FIG. 2 provides an exemplary embodiment incorporated within an existing PPS 70. Data for the PPS is stored in data bases 72 and an extract of the relevant data (see below) is prepared 58 and passed along to the Inventory Optimizer 54. In this exemplary embodiment, a user may access the Inventory Optimizer 54 using a suitable computer 56 equipped with an internet browser. From a screen in the browser, the user may choose an inventory strategy from the set displayed on a graph. Choosing the point then defines optimal policies for each SKU. After reviewing these policies and making any needed adjustments, the user may export said polices and adjustments back into the data bases 52 of the PPS. At this point the PPS controls inventory in the usual manner while making use of optimal policies.

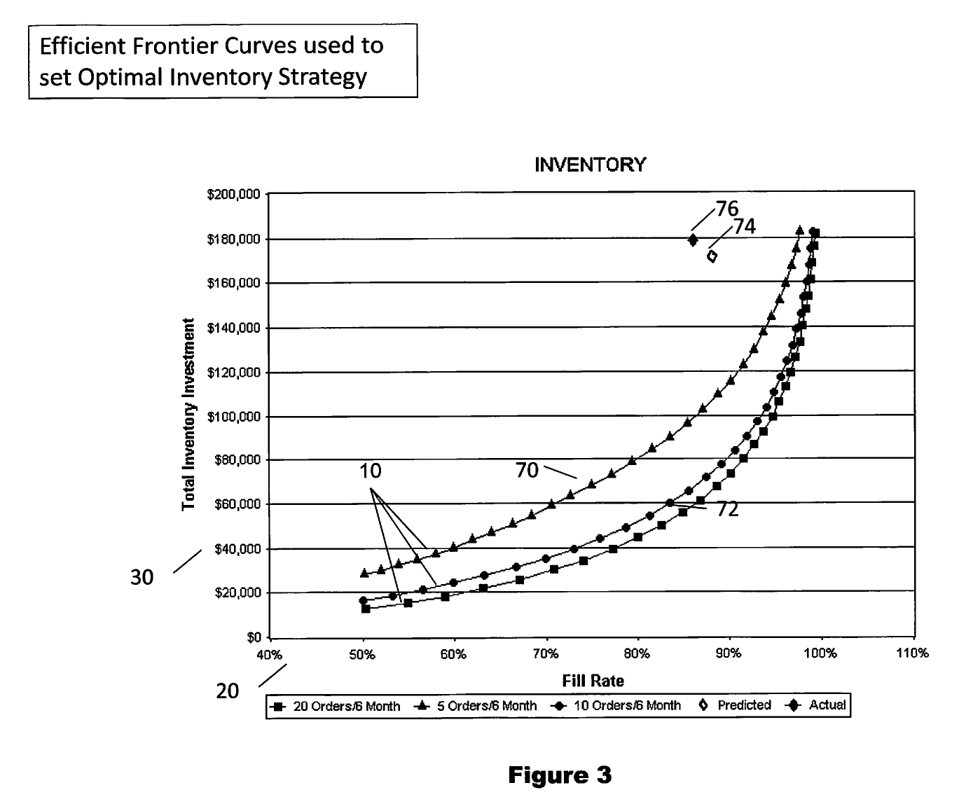

The user determines an optimal inventory strategy using a set of efficient frontier curves. FIG. 3 provides an exemplary embodiment of such curves 10. The curves show total expected inventory investment 30 plotted against the aggregate fill rate 20. The curves are “efficient” in that each point represents an inventory strategy for which no other strategy exists that would result in both less inventory and a higher fill rate operating with the same number of replenishments. For instance, the point indicated by point 70 has roughly a 75% fill rate with around $70,000 of inventory investment while replenishing a total of 5 times within 6 months (for all SKUs in the stock being considered). The point is efficient in that no policy exists that could have both less inventory investment with better fill rate and 5 replenishments. Likewise, point 72 represents a point with 10 replenishments in 6 months, a fill rate of around 84% and $60,000 invested in inventory. Point 76 represents the current performance of the inventory system (i.e., the current on hand investment, the historical aggregate fill rate, with 10 orders in six months). Point 74 represents a prediction of the performance by the Inventory Optimizer using a stochastic simulation model along with the data for each SKU and the policies currently being used. The current average number of reorders is 10 per 6 months for a set of 5 SKUs. Point 76 is not efficient because it is dominated by any of a number of points (each corresponding to a set of policies) on the 10 order curve that has less inventory and a greater fill rate.

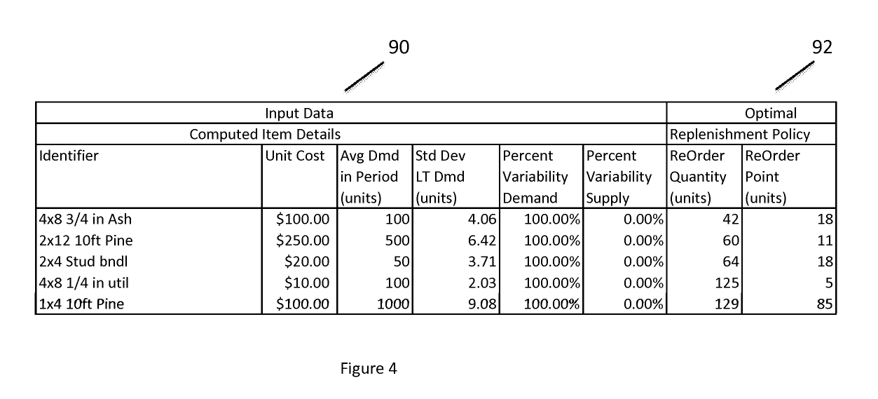

The user of embodiments of the present disclosure can choose any efficient point thereby selecting an optimal inventory strategy in that no other strategy can achieve the resulting fill rate within the capacity constraint with less inventory. Once the strategy is selected, the user can determine optimal policies for each SKU. FIG. 4 is an exemplary embodiment of the output for five SKUs showing input data 90 and the computed optimal policy parameters 92. In this exemplary embodiment the optimal policy parameters take the form of reorder points (ROP) and reorder quantities (ROQ). Such parameters are useful in PPSs that make use of ROP/ROQ ICMs. Other embodiments of the disclosure have been designed to generate policy parameters that can be used in time-phased reorder points systems also knows as material requirements planning or MRP. In such systems the policy parameters could take the form of planned lead times, safety stock levels, days of supply, and so on. Once the policy parameters are computed they are then inserted into a PPS (FIG. 2, 82). The PPS then controls the inventory using the optimal parameters in the usual way.

The methods of the disclosure consider inherent randomness to be robust enough to accommodate moderate changes in demand and capacity without the need to determine new policies.

Embodiments of the disclosure may be implemented in a number of ways. For example, a computer-implemented method for determining inventory policies for a plurality of stock keeping units (SKUs) may be provided. The method may include the steps of determining a probability of shortage for the demand associated with at least one of the plurality of SKUs, determining expected inventory levels for at least one of the plurality of SKUs in the stock, and generating output showing the probability of no shortages associated with at least one of the plurality of SKUs and the expected inventory investment for the at least one of the plurality of SKUs.

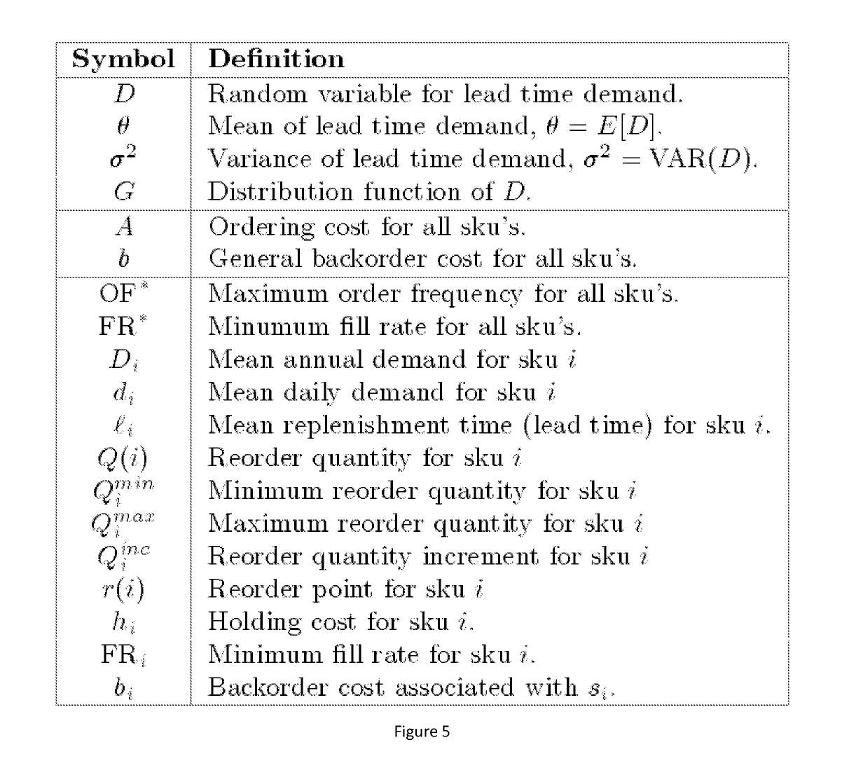

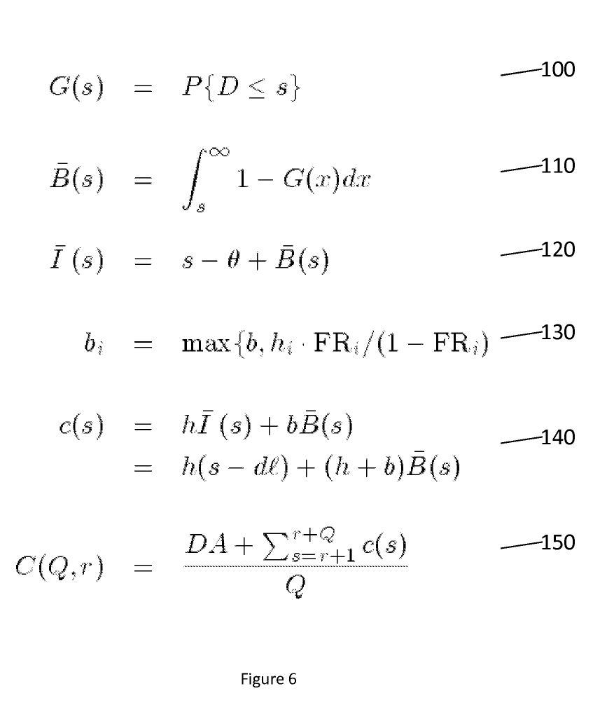

Certain embodiments may further utilize data for each SKU under consideration. An exemplary embodiment would use data for the mean and variance of the number of demand instances, the mean and variance of the size of the instances, the mean and variance of the replenishment times, the standard cost of the item, or some combination of the above. Another embodiment might use, instead of the four demand data describe above, the forecast error (i.e., the mean square error of the forecast over the replenishment times) and the average demand. Regardless of the data used, the goal is to compute and characterize the probability distribution of the lead time demand, (i.e., the random demand that occurs within a random replenishment (or lead) time). Symbols for the data are shown in FIG. 5 and the basic calculations are shown in FIG. 6. The probability distribution 100 for the lead time demand D may be used to compute the expected backorder level in 110. Expected backorders may be used to compute expected inventory in 120.

The constraint on the number of replenishment orders and the constraint on the service level are achieved by use of a Lagrange multiplier. The backorder cost, bᵢ, serves as a Lagrange multiplier for service levels for each SKU, bᵢ, is given in 130 and below. If FRᵢ is the minimum fill rate for SKU i and hᵢ is its holding cost, then the computed backorder cost will guarantee at least the minimum fill rate,

bᵢ=max{b,h, FR/(1−FR)}

The sum of the inventory investment and the backorder cost for a given inventory position is shown in 140. The inventory position is the sum of the on hand inventory plus what is on order minus any backorders. The imputed cost of the policy is given in 150 where A represents the Lagrange multiplier or the imputed order cost for each replenishment. Thus, 150 represents the sum of inventory holding cost, backorder cost and the order cost.

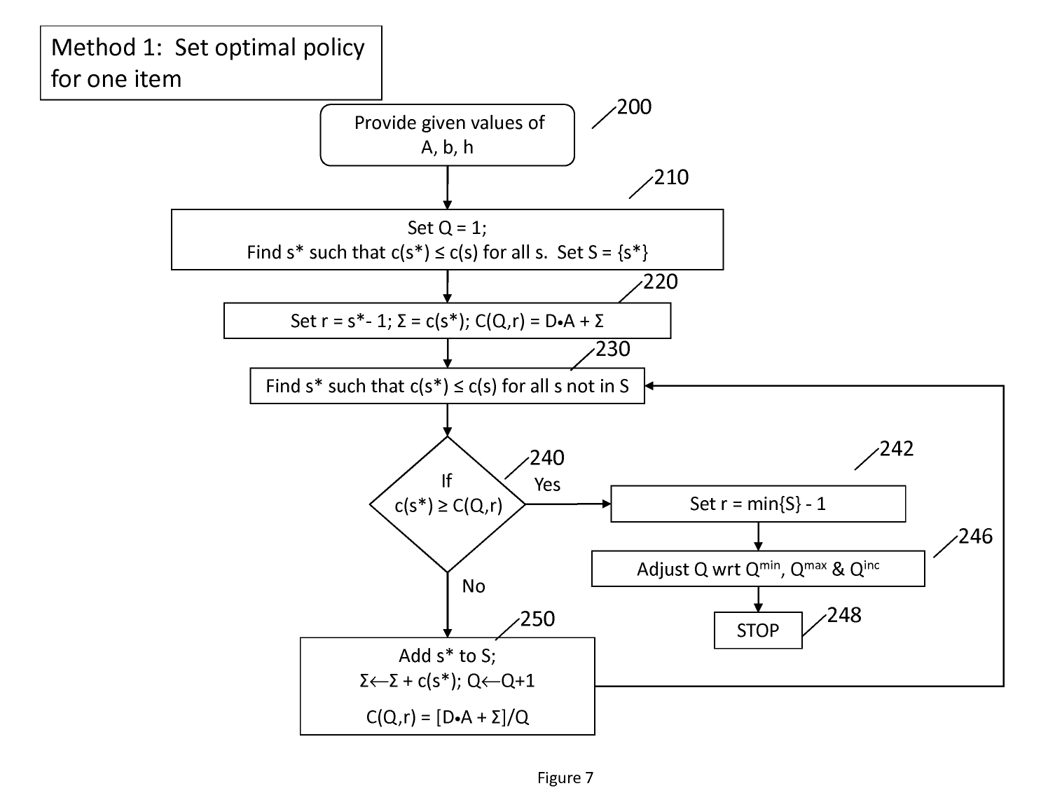

FIG. 7 is a flow diagram describing an embodiment of the procedure used to find an optimal policy for one item, according to principles of the present disclosure. This procedure will minimize the sum by determining the values of Q and r that minimize the total cost, C(Q,r). Note that this process minimizes backorder cost and not stockout cost.

The procedure begins at 200 with given the ordering cost for all SKUs, A, the general backorder cost for all SKUs, b, and the holding cost for all SKUs, h.

In 210, the reorder quantity, Q, is first set to 1 and the value s* is found by searching for the value that results in the minimum value of c(s). This value is stored in a collection called S.

The next step 220 sets r to the trial value of s*−1, computes the initial value of the sum, Σ=c(s*), and computes the solution value, C(Q,r)=D·A+Σ.

At step 230 the next smallest value of c(s) is found and this is again designated as s*. If c(s*) is greater than the current value of C(Q,r), the value of C(Q,r) cannot be reduced by taking adding c(s*) to the sum Σ while simultaneously incrementing Q.

Step 240 makes this comparison. If the comparison is true then the best values of Q and r will have been discovered.

Step 242 sets Q to be the current value while r will be the smallest value in the collection S minus 1.

However, if 240 is not true then the procedure must consider another point at step 250 where s* is added to the collection S, the sum Σ is increased by c(s*), Q is incremented by 1, and C(Q,r) is recomputed using the new values.

The procedure then moves back to step 230 and continues until condition 240 is satisfied. The procedure is guaranteed to converge for values of b and h that greater than zero and values of A that are greater than or equal to zero.

Once condition 240 is satisfied, r is given by the smallest value contained in the collection S minus 1. Block 246 adjusts value of Q so that it does not fall below Q^{min}, or exceed Q^{max}. Furthermore, it is adjusted to be a multiple of Q^{inc}. The Method then stops in block 248.

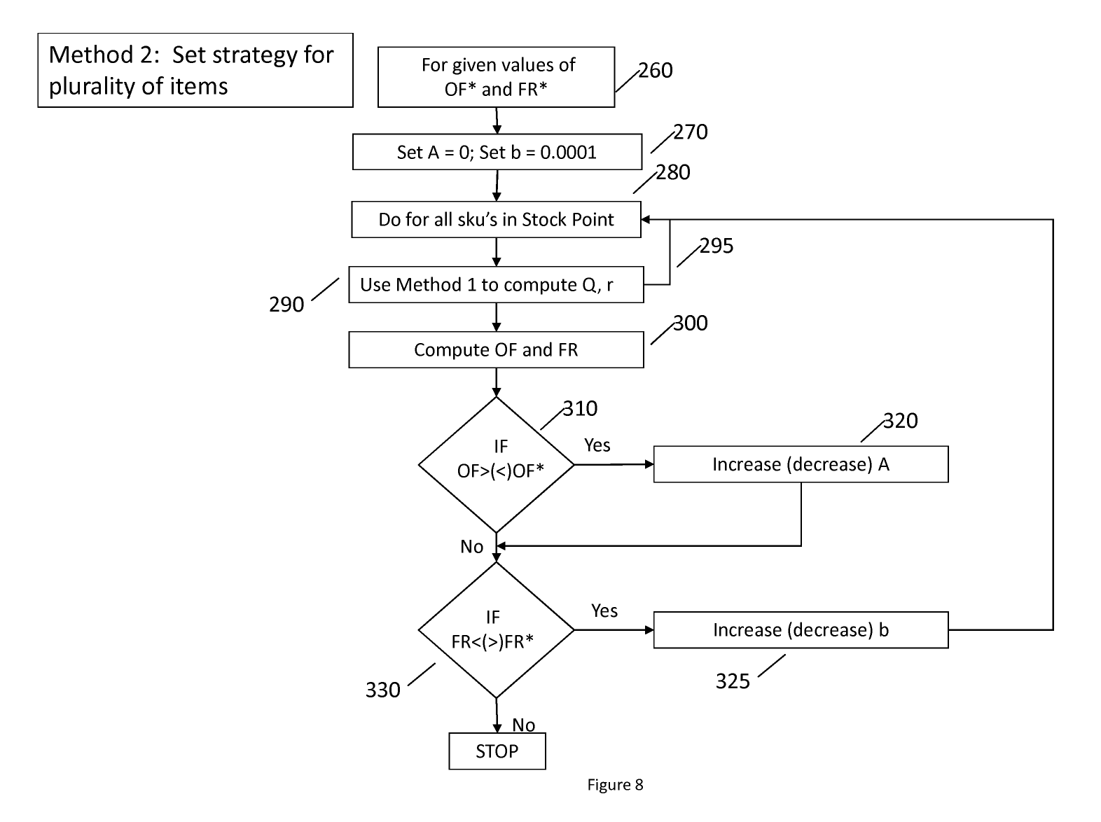

Once the optimal policy for a single SKU has been determined, a strategy for a plurality of SKUs may be calculated. Method 2, presented as a flow diagram in FIG. 8, is an exemplary algorithm for setting an inventory strategy for plurality of SKUs.

The procedure begins with a selection of a target fill rate, FR*, and a target order frequency, OF* in block 260.

Block 270 sets initial values for the order cost, A, to zero and the backorder cost, b, to a small value (here 0.0001).

A loop over all SKUs begins in block 280 and continues in block 290 where Method 1 is applied to compute values of Q and r for each SKU.

Block 300 computes the resulting OF and FR for the entire collection of SKUs using the procedure outlined above.

Blocks 310 checks to see if the operating frequency (OF) is at the target OF*. If the resulting OF is above OF*, then A must be increased. If it is too low, A must be decreased. A similar process (330) is used to find b such that the fill rate (FR) matches FR*. It is possible to find A and b that will match FR to FR* and OF to OF* to any given precision.

If both measures sufficiently match the desired quantities, the procedure is stopped, otherwise it continues at block 280.

Certain embodiments of the disclosure would present total inventory investment versus an aggregate fill rate. This is accomplished using Method 3 which employs Method 2 to prepare an efficient frontier curve.

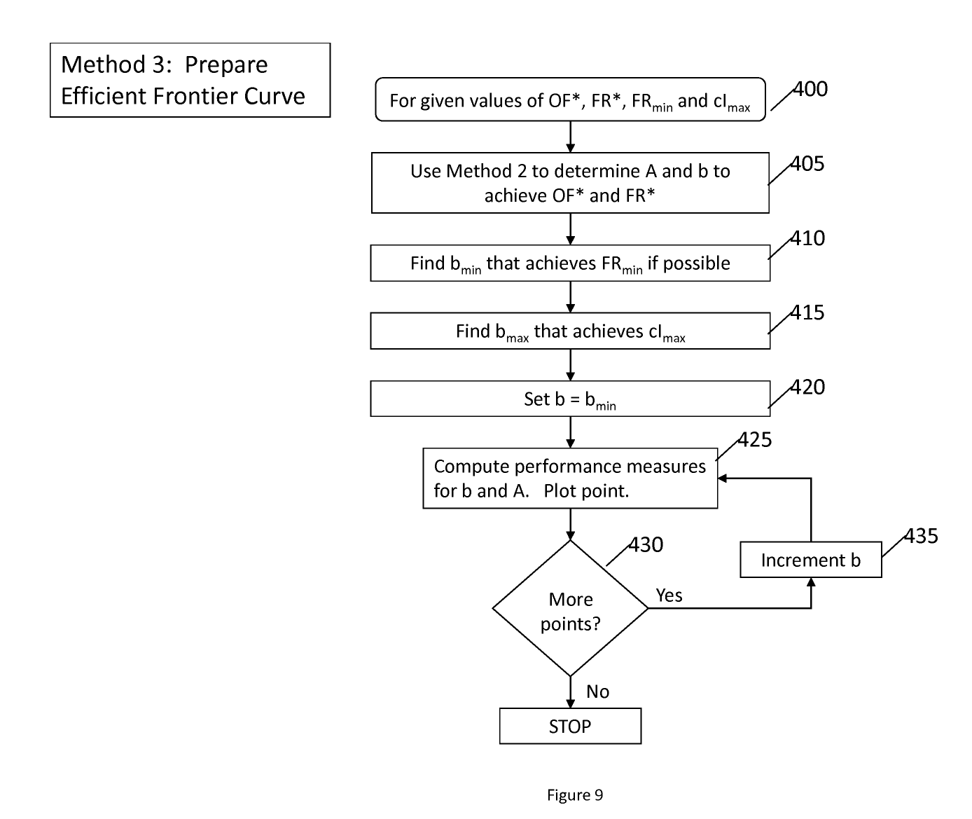

FIG. 9 provides a flow diagram of Method 3 beginning with the selection of plotting parameters in block 400.

Block 405 sets the fill rate to the minimum fill rate.

Block 410 determines the fill rate that results in the maximum inventory investment. The plot will be between the minimum fill rate and this fill rate.

Method 2 is applied in block 415 to determine A and b that achieve the desired order frequency and the current fill rate.

Block 425 employs Method 1 using this value of b and the previously computed value of A to compute the values for Q and r or all SKUs. Using these values of Q and r, the measures of OF and FR are computed for the entire collection and plotted.

Block 430 checks to see if there are more points to be plotted. If so, the fill rate is incremented and the procedure continues in Block 415. Otherwise, the curve is complete and the procedure stops.

Another embodiment may produce a curve of backorder days versus inventory investment. Method 3 may be modified to provide this plot as well.

Embodiments may require inputs for each SKU of minimum fill rate (greater than 0 and less than 1), item cost (greater than 0), average demand (greater than 0), variance of demand or forecast mean squared error (greater than or equal to zero), average lead time (greater than zero), variance of lead time (greater than or equal to zero), minimum order quantity (greater than zero), order quantity increment (greater than zero), maximum order quantity (greater than or equal to the minimum order quantity). It also requires several aggregate measures including target order frequency (greater than zero) and target fill rate (greater than zero and less than one).

In addition to providing inventory policies for individual items to be sold, it can also be used to provide policies for raw materials, spare parts, and any other stock that is to be maintained for future use.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the present disclosure may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM and so forth. A software module may comprise a single instruction, or many instructions, and may be distributed over several different code segments, among different programs and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein, such as those illustrated in the Figures, can be downloaded and/or otherwise obtained by a mobile device and/or base station as applicable. For example, such a device can be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a mobile device and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims

While the foregoing is directed to embodiments of the present disclosure, other and further embodiments of the disclosure may be devised without departing from the basic scope thereof, and the scope thereof is determined by the claims that follow.

1. A method for selecting an optimal inventory strategy for a plurality of stock keeping units (SKUs), comprising:
selecting an optimal policy for each SKU of the plurality of SKUs based, at least in part, on a potential backorder delay of each SKU;
calculating a set of efficient frontier curves based on the optimal policy for each SKU of the plurality of SKUs;
displaying the set of efficient frontier curves illustrating the relationship between a set of service levels and a total inventory investment; and
selecting the optimal inventory strategy for the plurality of SKUs based, at least in part, on the set of efficient frontier curves.

2. The method of claim 1, wherein selecting an optimal policy for each SKU of the plurality of SKUs comprises:
calculating a probability of meeting a service demand with on hand stock for each SKU of the plurality of SKUs;
determining an inventory investment for each SKU of the plurality of SKUs; and
generating an output showing the probability of satisfying the service demand with on hand stock associated with each SKU and the expected inventory investment for each SKU.

3. The method of claim 2, wherein calculating a probability of meeting the service demand with on hand stock is based on a probability distribution of a demand lead time and a corresponding mean and variance of the probability distribution.

4. The method of claim 1, wherein calculating a set of efficient frontier curves comprises determining a set of possible inventory strategies based on the optimal policy for each SKU of the plurality of SKUs;

5. The method of claim 4, wherein determining a set of possible inventory strategies is based on a possible order frequency for each SKU of the plurality of SKUs.

6. An apparatus for selecting an optimal inventory strategy for a plurality of stock keeping units (SKUs), comprising:
means for selecting an optimal policy for each SKU of the plurality of SKUs based, at least in part, on a potential backorder delay of each SKU;
means for calculating a set of efficient frontier curves based on the optimal policy for each SKU of the plurality of SKUs;
means for displaying the set of efficient frontier curves illustrating the relationship between a set of service levels and a total inventory investment; and
means for selecting the optimal inventory strategy for the plurality of SKUs based, at least in part, on the set of efficient frontier curves.

7. The apparatus of claim 6, wherein the means for selecting an optimal policy for each SKU of the plurality of SKUs comprises:
means for calculating a probability of meeting a service demand with on hand stock for each SKU of the plurality of SKUs;
means for determining an inventory investment for each SKU of the plurality of SKUs; and
means for generating an output showing the probability of satisfying the service demand with on hand stock associated with each SKU and the expected inventory investment for each SKU.

8. The apparatus of claim 7, wherein the means for calculating a probability of meeting the service demand with on hand stock is configured to utilize a probability distribution of a demand lead time and a corresponding mean and variance of the probability distribution.

9. The apparatus of claim 6, wherein the means for calculating a set of efficient frontier curves is configured to determine a set of possible inventory strategies based on the optimal policy for each SKU of the plurality of SKUs;

10. The apparatus of claim 9, wherein determining the set of possible inventory strategies is based on a possible order frequency for each SKU of the plurality of SKUs.

11. A computer-program product for selecting an optimal inventory strategy for a plurality of stock keeping units (SKUs) in a suitable computer, the computer-program product comprising a computer readable medium having instructions thereon, the instructions comprising:
code for selecting an optimal policy for each SKU of the plurality of SKUs based, at least in part, on a potential backorder delay of each SKU;
code for calculating a set of efficient frontier curves based on the optimal policy for each SKU of the plurality of SKUs;
code for displaying the set of efficient frontier curves illustrating the relationship between a set of service levels and a total inventory investment; and
code for selecting the optimal inventory strategy for the plurality of SKUs based, at least in part, on the set of efficient frontier curves.

12. The computer readable medium of claim 11, wherein code for selecting an optimal policy for each SKU of the plurality of SKUs comprises:
code for calculating a probability of meeting a service demand with on hand stock for each SKU of the plurality of SKUs;
code for determining an inventory investment for each SKU of the plurality of SKUs; and
code for generating an output showing the probability of satisfying the service demand with on hand stock associated with each SKU and the expected inventory investment for each SKU.

13. The computer readable medium of claim 12, wherein code for calculating a probability of meeting the service demand with on hand stock utilizes a probability distribution of a demand lead time and a corresponding mean and variance of the probability distribution.

14. The computer readable medium of claim 11, wherein code for calculating a set of efficient frontier curves comprises code for determining a set of possible inventory strategies based on the optimal policy for each SKU of the plurality of SKUs;

15. The computer readable medium of claim 14, wherein code for determining a set of possible inventory strategies utilizers an order frequency for each SKU of the plurality of SKUs.
